(19) United States
(12) Patent Application Publication
(10) Pub. No.: US 2016/0325540 A1
(43) Pub. Date: Nov. 10, 2016

(54) Apparatus And Method For Automated Application Of Seal Strips To Article Carrier Components

(71) Applicant: JAC Products, Inc., Saline, MI (US)

(72) Inventors: Thomas B. LAVIOLETTE, Ortonville, MI (US); Michael C. BLOM, Toledo, OH (US); Jason BONAMINIO, Lambertville, MI (US)

(21) Appl. No.: 14/706,421

(22) Filed: May 7, 2015

(51) Int. Cl. B32B 37/10; B32B 37/14

(52) U.S. Cl. CPC B32B 37/1018; B32B 37/14

(57) ABSTRACT

The present disclosure relates to an apparatus and method for applying sealing strips in an automated fashion to the edges of an article carrier support rail. The apparatus uses a vacuum force to hold at least one seal strip in a channel of a first nest assembly. The first nest assembly is rotationally supported and may be into a position adjacent to a second nest assembly. The second nest assembly is configured to hold an external component, for example an article carrier support rail, in an orientation so that a predetermined area thereof can receive the seal strip. The first nest assembly applies the seal strip to the predetermined area of the external component in a highly precise, repeatable and rapid fashion.

### FIELD

The present disclosure relates to apparatus and methods for applying a seal strip to an external component, and more particularly to an apparatus and method for applying a seal strip having an adhesive backing to an edge of an external component in a highly accurate, quick and repeatable fashion.

### BACKGROUND

The statements in this section merely provide background information related to the present disclosure and may not constitute prior art.

In article carrier systems, it is common to apply a strip of seal material to the peripheral edges of a support rail. The support rail forms an elongated component which is configured to be fixedly attached to the outer roof surface of a vehicle. Typically a pair of support rails are secured to the roof surface of the vehicle. One or more cross bars may be secured to the support rails, and the support rails may include channels for assisting in facilitating attachment of the cross bars thereto.

Typically the edges of the support rail that make contact with the vehicle roof surface have somewhat of a slight arcuate shape, as a result of the roof surface of the vehicle typically having a very slight curvature. It is required to apply a sealing material to the peripheral edges of a support rail, which acts like a weather-stripping material, to keep out rain, moisture and other elements from the interior area of the support rail once it is secured to the vehicle roof surface. Without the sealing material, rain and moisture may potentially make its way through openings in the roof surface where fasteners extend through the roof to engage with interior portions of the support rail, thus securing the support rail to the roof.

The seal material is typically a foam-like strip of material with adhesives on opposing surfaces, each covered with a removable paper backing material. An individual applying the seal material must carefully align the strip of seal material, which typically may be 4-6 feet in length, along each peripheral edge of the support rail, one edge at a time. This requires considerable care and skill by the individual. The individual must first remove one of the paper backing strips, then align the exposed adhesive side of the seal material with the peripheral edge to be covered, and then carefully, gradually lower the strip of seal material into contact with the peripheral edge. Since the edge is often only about 0.25 inch or less in thickness, the lowering and application of the strip of seal material must be done slowly so that it is placed precisely over the peripheral edge. If the seal strip starts to run off to one side or the other of the peripheral edge, the individual performing the application must lift a portion of the strip of seal material off of the peripheral edge, re-align the free portion of the strip of seal material, and then re-lower the free portion of the strip of seal material into contact with the peripheral edge. In practice, an inexperienced installer may need to perform this action several times during the application of one seal strip. And the more that the installer touches the adhesive, the more chance there is that oils or contaminants from the installer's fingers may be deposited on the adhesive, thus compromising the attachment once the seal strip is fully applied to the peripheral edge. Even with a skilled installer, the seal strip may still not be perfectly aligned over the full length of the peripheral edge. Depending on the degree of misalignment, there may be an increased risk of water, moisture or other contaminants eventually entering into the area under the support rail after its attachment to the roof. And a seal strip that is not applied perfectly along the peripheral edges of the support rail can create an aesthetically unappealing appearance as well.

Accordingly, there exists a need for a machine and method which enables a plurality of seal strips to be applied to the peripheral edges of an article carrier component in a highly precise manner, and more rapidly than could be accomplished by even an experienced installer.

### SUMMARY

In one aspect the present disclosure relates to an apparatus for rapidly and accurately applying seal strips to a surface of an external component along a predetermined location on the external component. The apparatus may comprise a plurality of elements including a support table, a first nest assembly, a bearing assembly, a second nest assembly and a vacuum source. The first nest assembly may have a plurality of vacuum passages leading to a plurality of vacuum ports. The vacuum ports may be formed in a first channel of the upper nest assembly. The channel is shaped to hold a seal strip therein and has a predetermined length and shape. The at least one bearing assembly may be used to support the first nest assembly for rotational movement relative to the support table. The second nest assembly is positioned fixedly relative to the support platform on the support table, and configured to removably hold the external component in a desired orientation. The vacuum source supplies a vacuum force to the vacuum ports to hold the seal strip within the channel as the first nest assembly is rotated towards the second nest assembly. The first nest assembly applies the seal strip to the predetermined location of the external component when the first nest assembly is fully rotated into a position closely adjacent the second nest assembly. Rotation of the first nest assembly away from the second nest assembly allows the external component, with the seal strip secured thereto, to be removed from the second nest assembly.

In another aspect the present disclosure relates to an apparatus for rapidly and accurately applying seal strips to a pair of generally parallel edges of an article carrying component along a predetermined location on the article carrying component. The apparatus may comprise a support table, an upper nest assembly, a plurality of bearing assemblies, a lower nest assembly and a vacuum source. The upper nest assembly has a plurality of vacuum passages leading to a plurality of vacuum ports. The vacuum ports are formed in first and second generally parallel channels of the upper nest assembly. The channels are shaped to hold first and second seal strips therein and the channels each have a predetermined length and shape. The plurality of bearing assemblies supports the upper nest assembly for rotational movement relative to the support table. The lower nest assembly is positioned fixedly relative to the support table and configured to removably cradle the article carrying component in a desired orientation, with the edges of the article carrying component facing outwardly. The vacuum source supplies a vacuum force to the vacuum ports to hold the seals strips within the channels as the seal strips are manually positioned in the channels by a user. The upper nest assembly further uses the vacuum force to hold the seal strips in the channels as the upper nest assembly is rotated towards the lower nest assembly. The upper nest assembly applies the seal strips to the edges of the article carrying component with a predetermined force when the upper nest assembly is fully rotated into a position closely adjacent the lower nest assembly. Thereafter, rotation of the upper nest assembly away from the lower nest assembly allows the article carrying component, with the seal strips secured thereto, to be manually removed from the lower nest assembly.

In still another aspect the present disclosure relates to a method for rapidly and accurately applying seal strips to a surface of an external component along a predetermined location on the external component. The method may comprise initially providing a support table. The method may also involve using a first nest assembly having a plurality of vacuum passages leading to a plurality of vacuum ports to hold a seal strip. The vacuum ports may be formed in a channel of the upper nest assembly. The channel may be shaped to hold the seal strip therein and the channel may have a predetermined length and shape. The method may involve using at least one bearing assembly to support the first nest assembly for rotational movement relative to the support table, and using a second nest assembly positioned fixedly relative to the support platform, to removably hold, in a cradle-like manner, the external component in a desired orientation. The method may use a vacuum source to supply a vacuum force to the vacuum ports to hold the seal strip within the first channel as the seal strip is positioned in the channel by a user. The method may also involve rotating the first nest assembly towards the second nest assembly while the seal strip is held in the channel using the vacuum force. The first nest assembly may be used to press the seal strip onto the predetermined location of the external component, with a predetermined force, as the first nest assembly is fully rotated into a position closely adjacent to the second nest assembly. The first nest assembly may then be rotated away from the second nest assembly to allow the external component, with the seal strip secured thereto, to be removed from the second nest assembly.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level perspective view of an apparatus in accordance with one embodiment of the present disclosure for applying a plurality of seal strips simultaneously, and in one motion, to the peripheral edges of an article carrier component;

FIG. 2 is a view of the apparatus shown in FIG. 1 but with the apparatus in a closed orientation applying a force to the sealing strips to press them against the peripheral edges of the article carrier component;

FIG. 3a is a simplified plan view of just one support section of the apparatus illustrating the internal passages in dashed lines which communicate with the vacuum ports, to thus enable a vacuum holding force to be applied to a pair of seal strips positioned on a face of the support section;

FIG. 3b is a high level plan view of just a portion of an upper nest assembly of the apparatus, illustrating the channels where the seal strip may be placed, and the vacuum ports present in each of the channels to temporality hold the seal strips in the channels during application of the seal strips to the peripheral edges of an article carrier component;

FIG. 4 is a plan view of one of the channels illustrating a portion of a seal strip positioned therein with the paper backing on one side of the seal strip having been removed, thus exposing the adhesive underneath;

FIG. 5 is a simplified cross sectional drawings taken in accordance with section line 5-5 in FIG. 4 of just one of the channels of the upper nest assembly, showing a portion of the seal strip being held in the channel by a vacuum force provided by the vacuum ports; and

FIG. 6 is a view of an alternative form of upper nest assembly in which the assembly includes a removable, replaceable track to allow seal strips to be applied to differently shaped article carrier components.

### DETAILED DESCRIPTION

The following description is merely exemplary in nature and is not intended to limit the present disclosure, application, or uses. It should be understood that throughout the drawings, corresponding reference numerals indicate like or corresponding parts and features.

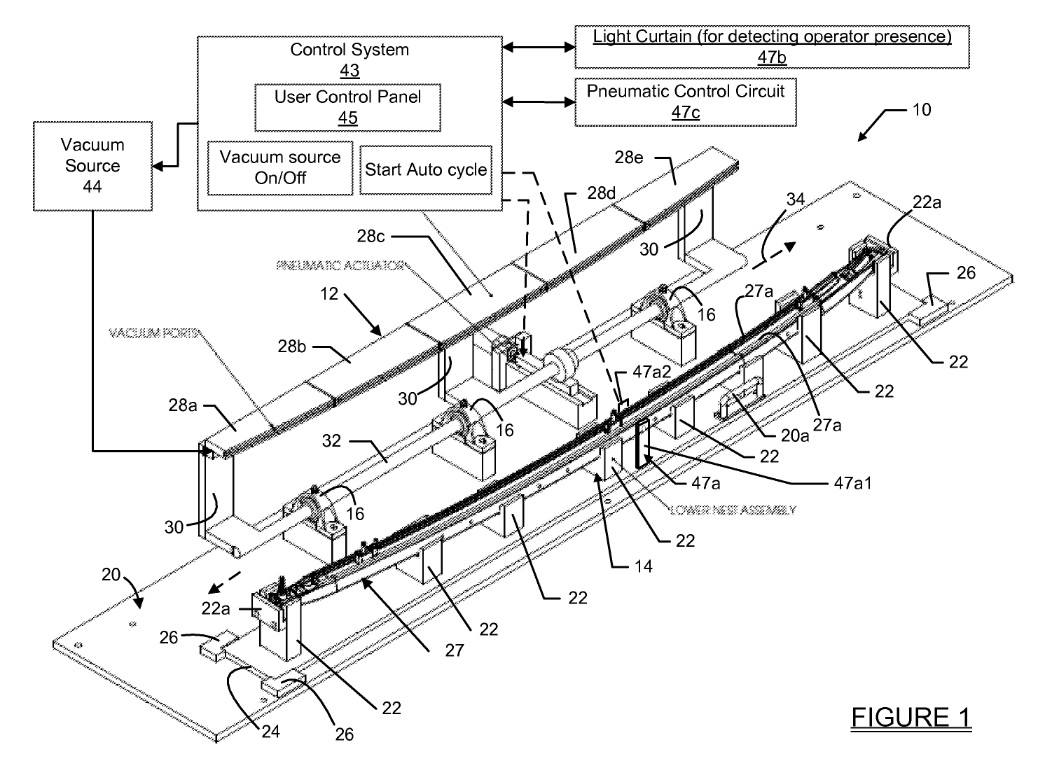

Referring to FIG. 1 there is shown an apparatus 10 for applying a seal strip in an automated fashion to the peripheral edges of an external component. In this example the external component is an article carrier support rail which is intended to eventually be fixedly secured to a roof surface of an automotive vehicle, to thus form a portion of an article carrier rack system. However, it will be appreciated immediately that the teachings of the present disclosure may be applied to virtually any type of component which requires a sealing strip to be applied to an edge or surface portion of an external component. The apparatus 10 is expected to find utility in any application where a seal strip needs to be applied in a highly precise, rapid and repeatable manner to an edge or surface of an external component.

In FIG. 1 the apparatus 10 can be seen to include a first or “upper” nest assembly 12 and a second or “lower” nest assembly 14. The upper nest assembly 12 is supported for pivotal movement by a plurality of bearings 16 supported from mounting blocks 18. The mounting blocks 18 are supported on a platform or main table 20. The lower nest assembly 14 is formed by a plurality of supports 22 which in this example are secured to an intermediate platform 24 to form a unitary assembly. The intermediate platform 24, in turn, can be removable secured to the main table 20 via a plurality of bracket members 26. Thus, in this example, the lower nest assembly 14 may be viewed as including the supports 22 and the intermediate platform 24. Handle 20a may be used to help lift and position the entire lower nest assembly 14 into position on the main table 20.

The supports 22 of the lower nest assembly 14 have an upwardly facing U-shaped configuration which is dimensioned and shaped to hold an external support rail 27 therein. In this regard it will be appreciated that the support rail 27 typically has a slight curvature over its entire length. The degree of curvature will depend on the curvature of the vehicle roof that the support rail 27 is intended to be installed on. Thus, the supports 22 will typically have slightly varying heights so that the supports 22 can “cradle” the support rail 27 securely over its entire length. The outermost supports 22 also may include end plates 22a that ensure that the support rail 27 is placed on the supports 22 in a highly precise longitudinal position, relative to the upper nest assembly 12.

From FIG. 1 it will also be noted that the support rail 27 is placed on the supports 22 in an upside down fashion. In this manner, two generally parallel edges 27a of the support rail 27 will be facing upwardly. The support rail 27 is cradled securely in the supports 22 so that it is not able to rock or move either laterally or longitudinally once seated on the supports 22, and will remain stable when a downward force is applied to the edges 27a.

With further reference to FIG. 1, the upper nest assembly 12 includes a plurality of seal strip supporting sections 28a-28e (hereinafter simply “supporting sections 28a-28e”), which may be secured releasably together via suitable braces and fasteners (not shown). It will be noted that the supporting sections 28a-28e, collectively, provide a slightly arcing contour, which is selected to match the slightly arcuate contour of the edges 27a of the support rail 27. Thus, it will be understood that the supporting sections 28a-28e will be constructed, both in length and contour, for a specific support rail.

The upper nest assembly 12 further includes a plurality of frame members 30 which support the supporting sections 28a-28e. The frame members 30 are also coupled to an elongated cylindrical member 32.

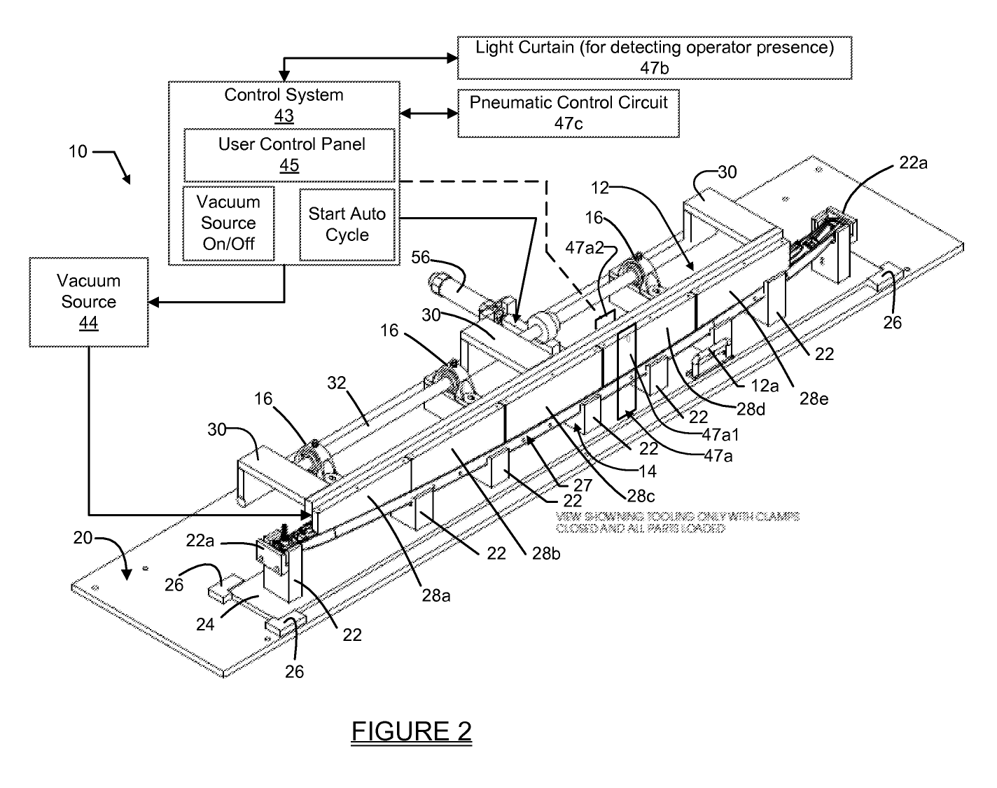

The elongated cylindrical member 32 enables the supporting sections 28a-28e to be moved rotationally about an axis 34 extending longitudinally through an axial center of the bearings 16. The upper nest assembly 12 is shown in its lowered position in FIG. 2 pressing against the upwardly facing edges 27a of the support rail 27.

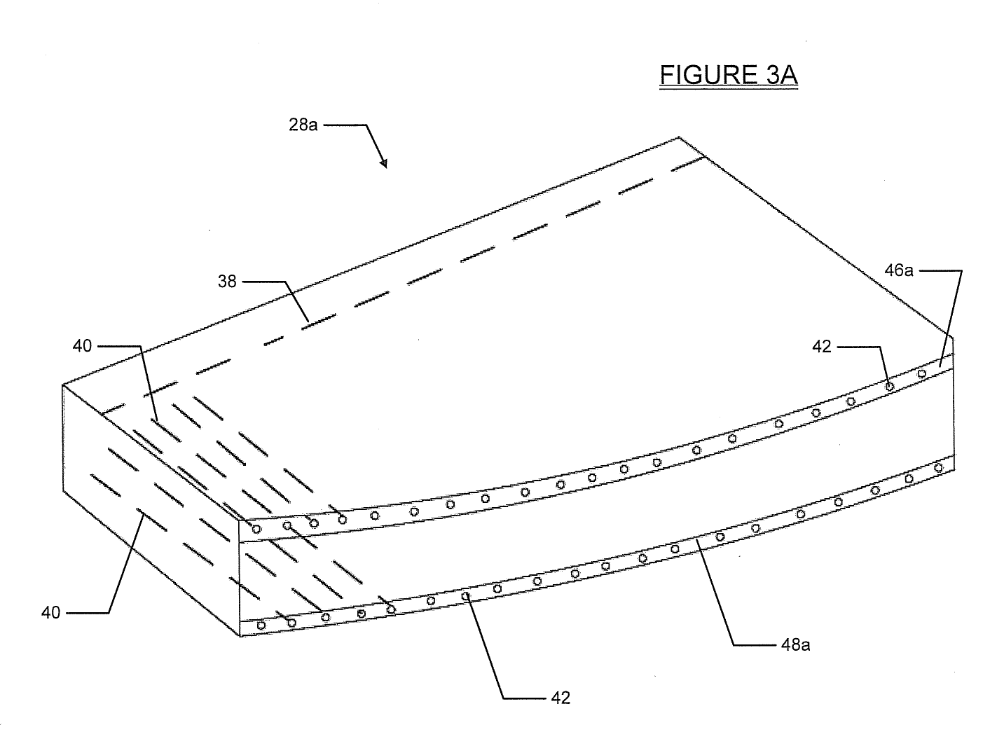

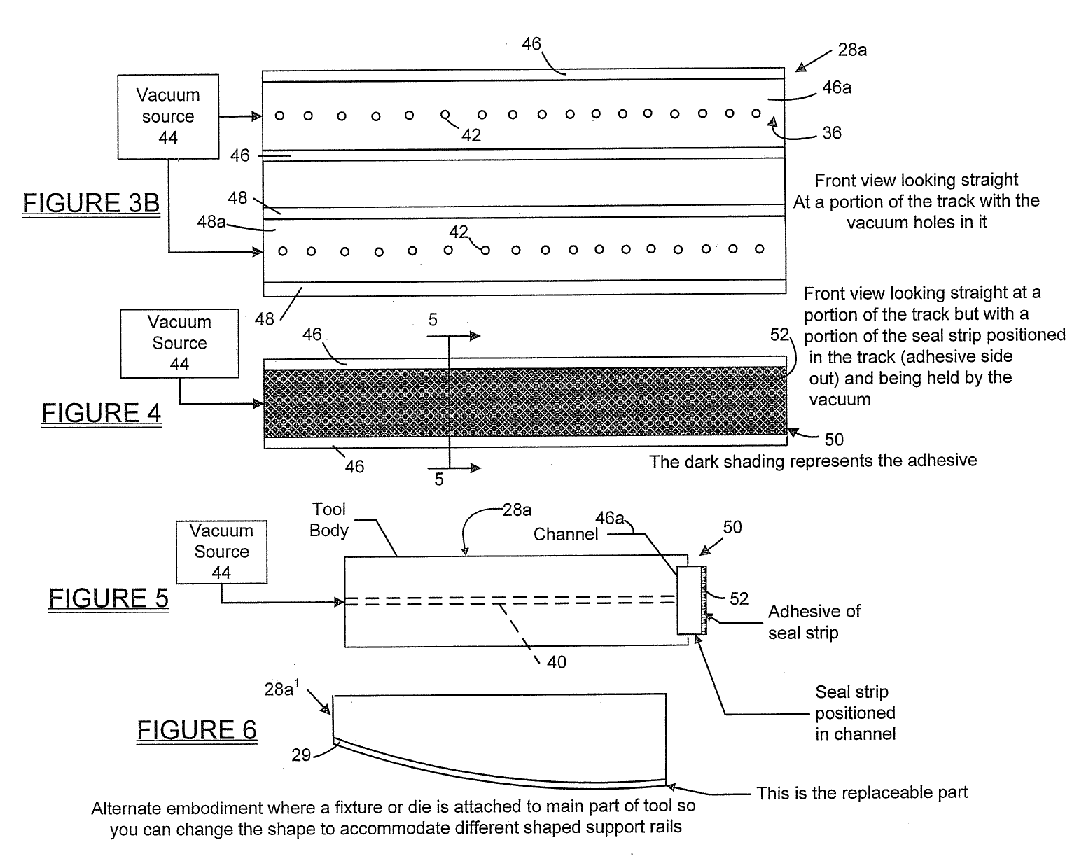

With reference to FIGS. 1, 3a and 3b, FIG. 3a shows supporting section 28a is shown in greater detail from a perspective view, and FIG. 3b shows a portion of supporting section 28a looking directly at a forward edge 36 of the supporting section 28a. In FIG. 3a the supporting section 28a can be seen to include an internal flow path 38 which communicates with a plurality of independent flow paths 40. Each of independent flow paths 40 terminate in a port 42. An external vacuum source, such as vacuum source 44 in FIG. 1, supplies a vacuum so that each port 42 provides a sucking force while the vacuum force is being applied.

Vacuum source 44 may be controlled by a processor based control system 43 which cooperates with an optical sensor system 47a and light curtain detection system 47b, to automatically turn on the vacuum as needed when a support rail 27 is sensed as being in position on the supports 22 and an operator is sensed as being in position in front of the apparatus 10. In this regard the optical sensor system 47a may direct an optical beam along a generally horizontal plane from an emitter 47a1 to a receiver 47a2, with the emitter 47a1 and receiver 47a2 being positioned such that the beam from the emitter 47a1 will be interrupted when the support rail 27 is positioned in the supports 22. The interruption is a first signal component that tells the control system 43 that the support rail 27 is in position on the supports 22 and ready to have a seal strip 50 (shown in FIG. 4) applied thereto. A second signal component is provided by the light curtain detection system 47b which tells the system that a user is present in front of the apparatus 10. The light curtain detection system 47b preferably emits a vertically oriented beam from a location at least about 6-12 inches in front of the supports 22, which is about where a user would be standing when operating the apparatus 10. The light curtain detection system 47b may include one or more infrared (IR) sensors, or any other suitable sensing component. The light curtain detection system 47b generates a beam pattern sufficiently wide to detect the presence of an individual in front of the supports 22 preferably at any longitudinal point along the upper nest assembly 12. Thus, the user does not need to be standing at precisely the midpoint of the support rail 27 to be detected by the light curtain detection system 47b. The light curtain detection system 47b is preferably located overhead of where the user would typically be standing when operating the apparatus 10, but again the beam pattern is configured to detect all areas where a user might normally be standing when operating the apparatus 10.

The control system 43 may be programmed to ignore the presence of the user if it knows that the seal strip 50 is present in the upper nest assembly 12, and that the support rail 27 is positioned on the supports 22. A third signal component may be generated by the control system 43 detecting when at least one of the vacuum ports 42 is blocked by a seal strip 50. The control system 43 in this embodiment detects when a plurality, preferably at least 4, longitudinally spaced apart vacuum ports 42 are blocked by the seal strip 50. Thus, when the required number of vacuum ports 42 is/are detected as being blocked, and simultaneously the support rail 27 is detected as being present on the supports 22, the control system 43 may automatically initiate the motion of the upper nest assembly 12 to apply the seal strip 50 to the support rail 27, regardless if a user is detected as being present or not in front of the apparatus 10. If no seal strip 50 is detected, and no support rail 27 is detected as being positioned on the supports 22 by the sensor system 47a, then the control system 43 may turn off the vacuum source 44. Optionally, the control scheme could require that the user move away from the apparatus 10 (as detected by the light curtain detection system 47b), before the control system 43 initiates lowering of the upper nest assembly 12. Those skilled in the art will understand that other control schemes could easily be implemented, depending on the whether one wishes the operator to be completely removed from the vicinity of the apparatus 10 before a cycle starts.

The control system 43 controls cycling of the upper nest assembly 12 by controlling a plurality of pneumatic actuators which form part of a pneumatic control circuit 47c. The pneumatic actuators cooperate with a conventional gear and rack system (not shown), and with conventional check valves (not shown), and also with the light curtain detection system 47b to both controllably lower and raise the upper nest assembly 12. Preferably, the control system 43 is programmed such that if a cycle is underway (i.e., the upper nest assembly 12 is in the process of being raised or lowered), and the user enters into the area being sensed by the light curtain detection system 47b, the control system 43 will control the pneumatic control circuit 47c to instantly interrupt motion of the upper nest assembly 12. The motion preferably will not continue until the user again is sensed by the light curtain detection system 47b to have left the vicinity of the apparatus 10. Such control circuits are well known in the art and a detailed explanation of operation of such a circuit is not necessary. One or more conventional electronic limit switches (not shown) may also optionally be positioned adjacent the supports 22 to detect when the upper nest assembly 12 has reached a fully lowered and/or a fully raised orientation during its operational cycling. The counterweight 56 is useful for balancing the upper nest assembly 12 so that it may remain stationary when its movement is stopped at any point along its path of travel.

Optionally, a user control panel 45 (FIG. 1) having a “Start Auto Cycle” button may be provided to allow a user to manually control the application of the vacuum and/or the overall cycling of the apparatus 10. It will be appreciated that each of supporting sections 28b-28e may be formed in a similar or identical manner to provide flow paths 38, 40, and ports 42.

The internal flow path 38 of each of supporting sections 28a-28e may thus be in communication with one another such that a vacuum is provided simultaneously at the ports 42 of each supporting section 28a-28e when vacuum source 44 is running.

FIG. 3b shows the forward edge 36 of supporting section 28a in greater detail. It will be appreciated that each of the supporting sections 28a-28e will include the structure of forward edge 36 shown in FIG. 3b. Forward edge 36 includes parallel wall portions 46 and parallel wall portions 48. Wall portions 46 form a channel 46a while wall portions 48 form a channel 48a that runs generally parallel to channel 46a. A plurality of the ports 42 are formed along the length of the channels 46a and 48a. The ports 42 may be spaced apart as needed to provide a sufficient vacuum force that holds a pair of seal strips securely in the channels 46a and 48a, by vacuum force alone, as the upper nest assembly 12 is being lowered toward the lower nest assembly 14. The spacing of the ports 42, in one embodiment of the apparatus 10, may be about 2-9 inches, which is expected to be sufficient for most applications, while a diameter of the ports 42 may be about 0.1 inch-0.2 inch.

It will also be appreciated that the channels 46a and 48a need not be perfectly parallel to one another; the actual shape of the channels 46a and 48a is selected in accordance with the layout and the widths of the edges 27a of the support rail 27 in mind. As such, with some support rails 27, the edges 27a may flare outwardly slightly towards the midpoint of the length, and in that instance the shapes of the channels 46a/48a would be formed to match the arcing slight curvatures of the edges 27a. In this example, for simplicity, it will be assumed that the edges 27a of the support rail 27 run perfectly parallel to one another.

In FIG. 3b, each channel 46a and 48a will thus be dimensioned to hold a seal strip having a specific width. FIG. 4 shows just channel 46a of the supporting section 28a with a portion of a seal strip 50 positioned therein. The seal strip 50 is a foam-like, weather stripping type material having adhesives on both opposing sides, each being covered with a removable backing tape. The removable backing tape covering the outwardly facing surface of the seal strip 50 has been removed in FIG. 3c to expose an adhesive 52. FIG. 4 shows a simplified side cross sectional view of the supporting section 28a with the seal strip 50 positioned therein. From FIG. 5 it can be seen that the depth of the channel 46a is such that a portion of the thickness of the seal strip 50 projects outwardly from the channel 46a. Thus, when the upper nest assembly 12 is rotated into its closed position (FIG. 2), the seal strip 50 is able to be compressed slightly with a predetermined force being applied by the upper nest assembly 12. The amount of predetermined force may be selected in part on the specific type of seal strip 50 being used, but it will be sufficient to firmly press the seal strips 50 against the edges 27a so that the adhesive 52 of each strip 50 makes excellent contact with its respective support rail edge 27a along the entire length of the support rail 27.

The apparatus 10 may also make use of a counterweight 56, as shown in FIG. 2. The counterweight 56 has a weight selected to largely offset the weight of the upper nest assembly 12 so that the user is able to easily lift the upper nest assembly back into its fully opened position from a lowered position with only a small amount of effort. In effect, the counterweight 56 acts much like a torsion spring to provide an assisting force which makes the upper nest assembly 12 feel to the user like it weighs only a few pounds. The counterweight 56 may also be secured so that it is adjustably positionable and securable along a shaft, to thus provide a means for adjusting the counterforce applied to counteract the weight of the upper nest assembly 12.

In operation of the apparatus 10, a user first turns on the vacuum source 44 from control panel 45 and then positions a pair of seal strips 50 in the channels 46a and 48a. The vacuum force provided by the vacuum source 44 will hold each seal strip 50 securely in its respective channel 46a or 48a as each seal strip is laid in its respective channel. Once the seal strips 50 are laid in the channels 46a and 48a, the backing tape may then be removed from the exposed face of each seal strip 50 to expose the adhesive 52 on each seal strip. The control system 43 will then automatically initiate motion of the upper nest assembly 12 to begin the cycle as soon as the user steps away from the apparatus 10, as detected by the light curtain detection system 47b. Optionally, if the apparatus 10 is designed to be manually controlled, then the user may manually lower the upper nest assembly 12 down until the adhesives 52 of the seal strips 50 contact the edges 27a of the support rail 27. To aid in lowering and lifting the upper nest assembly 12, a suitable handle (not shown) may be attached to one or more of the supporting sections 28a-28e. The counterweight 56 may also help to limit the force that the upper nest assembly 12 applies to the edges 27a to a predetermined value that would be well less than that provided by the weight of the upper nest assembly 12, and thus may significantly aid the user in raising the upper nest assembly 12 back to its fully open position. Once fully lowered, the force applied by the upper nest assembly 12 is sufficient so that the exposed adhesive 52 of each seal strip 50 is firmly seated against its respective edge 27a. Alternatively, if no counterweight 56 is used, the full weight of the upper nest assembly 12 may be relied on to apply the needed application force. In either event, the application force only needs to be applied for typically about one second or less to firmly seat the seal strips 50 in the channels 46a and 48a.

At this point the vacuum source 44 may be turned off and the upper nest assembly 12 manually lifted by the user to its fully open position as shown in FIG. 2. If the apparatus 10 is designed for manual operation, then a separate control may be incorporated in the user control panel 45 which the user may press to lift the upper nest assembly 45. Still further, another optional control scheme could be programmed into the control system 43 so that the user can start the process of lowering the upper nest assembly 12 with the press of a button, and the pneumatic actuator will automatically begin to lower the upper nest assembly 12 towards the edges 27a of the support rail 27 as soon as the light curtain detection system 43b detects that the user has moved away from the apparatus 10, and then control system 43 will thereafter automatically raise the upper nest assembly 12 back to the fully open position point without further action by the user. Moreover, the adhesion provided by the adhesives 52 on the seal strips 50 may be sufficiently strong so that the vacuum source 44 does not need to be cycled off before lifting the upper nest assembly 12 back to its fully open. Another benefit of the apparatus 10 is that it does not upset the backing tape on the covered side of the seal strip 50.

Once both seal strips 50 have been applied to the edges 27a of the support rail 27 the support rail may be lifted out of the supports 22 and a new support rail positioned on the supports. The process described above may be repeated with the user applying two new lengths of seal strips 50 into the channels 46a and 48a.

Referring to FIG. 6, a modification of the upper nest assembly 12 may involve providing each supporting section 28a-28e with a removably attached track 29 held on by threaded fasteners or clamps (not shown). One such supporting section 28a¹ is shown in FIG. 6. The track 29 may be constructed for a specific model of support rail. Thus, different model support rails will have different track sections that are configured, contoured and dimensioned precisely to match the configuration, contour, spacing and widths of the edges of a specific model of support rail. This enables the apparatus 10 to be quickly and easily set up to accommodate a variety of different model support rails having different lengths, widths and shapes. It will be appreciated that if tracks 29 are incorporated for each of the supporting sections 28, then corresponding modifications will likely need to be made to the supports 22 (FIGS. 1 and 2) to accommodate the differently shaped support rail. In practice, a separate intermediate platform 24 may be provided with the differently shaped and/or dimensioned supports 22. Thus, specific matched pairs of tracks 29 and supports 22 could be constructed to accommodate different shaped support rails, and changed out quickly and easily as needed.

It will also be appreciated that for the example support rail 27 discussed herein, the shape and contour of the rail is such that both the driver side and passenger side support rails 27 can be operated on by the system 10 without reconfiguring the supporting sections 28a-28e and the supports 22. However, if the driver side and passenger side support rails have slightly different contours or shapes (possibly a mirror image of one another), it may be necessary to replace the support sections 28a-28e and/or the supports 22 when applying seal strips 50 to both support rails 27. Optionally, it will be appreciated that the upper nest assembly 12 and the lower nest assembly 14 could be configured to process a pair of support rails 27 (or even more than one pair) simultaneously in one cycle of operation. This would be accomplished by configuring the upper nest assembly 12 to hold two pairs of seal strips 50, and the lower nest assembly 14 to hold both of the support rails 27 in a precise orientation relative to the positions of the 4 seal strips in the upper nest assembly 14. The apparatus 10 would apply both seal strips 50 simultaneously to the exposed edges of the pair of support rails 27 in one cycle of operation.

While the apparatus 10 has been described in connection with the application of seal strips on a luggage rack component (i.e., a support rail), it will be appreciated that the apparatus 10 may be used with only minor modifications to accommodate virtually any type of component which requires the application of a weather-stripping like element to an edge or surface thereof in a highly accurate and repeatable manner. The apparatus 10 described herein essentially eliminates the skill required by an operator when applying a seal tape in a “free hand” manner to a narrow edge of a component such as a support rail. The apparatus 10 applies the seal strips 50 in a highly precise, repeatable and rapid manner each and every cycle of its operation. The apparatus 10 furthermore allows an operator to apply a pair of the seal strips 50 to the edges of a support rail in just a few seconds, which would otherwise take an experienced individual possibly 2-4 minutes to accomplish if performing the application in a free hand manner. The highly precise manner in which the apparatus 10 applies the seal strips 50 to the edges 27a of the support rail 27 further produces a perfectly clean, aesthetically pleasing appearance when the application process is completed, and also when the support rail 27 is eventually installed on a vehicle.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

1. An apparatus for rapidly and accurately applying seal strips to a surface of an external component along a predetermined location on the external component, the apparatus comprising:
a support table;
a first nest assembly having a plurality of vacuum passages leading to vacuum ports, the vacuum ports being formed in a channel of the first nest assembly, the channel being shaped to hold a seal strip therein and the channel having a predetermined length and shape;
at least one bearing assembly for supporting the first nest assembly for rotational movement relative to the support table;
a second nest assembly positioned fixedly relative to the support platform on the support table, and configured to removably hold the external component in a desired orientation;
a vacuum source for supplying a vacuum force to the vacuum ports to hold the seal strip within the channel as the first nest assembly is rotated towards the second nest assembly; and
wherein the first nest assembly applies the seal strip to the predetermined location of the external component when the first nest assembly is fully rotated into a position closely adjacent the second nest assembly, and wherein rotation of the first nest assembly away from the second nest assembly allows the external component, with the seal strip secured thereto, to be removed from the second nest assembly.

2. The apparatus of claim 1, wherein the first nest assembly includes a pair of channels running generally parallel to one another, with the vacuum ports being positioned in the pair of channels, and wherein the pair of channels enables a pair of the seal strips to be held in the pair of channels by the vacuum force and applied simultaneously to the external component.

3. The apparatus of claim 1, wherein the seal strip is applied to an edge of the external component.

4. The apparatus of claim 1, further comprising a user control panel for enabling a user to control the vacuum source.

5. The apparatus of claim 1, wherein the first nest assembly comprises a plurality of supporting sections secured together to form a single, elongated assembly.

6. The apparatus of claim 1, further comprising a counterweight operably associated with the first nest assembly to counterbalance a weight of the first nest assembly and aid a user in manually rotating the first nest assembly towards and away from the second nest assembly.

7. The apparatus of claim 1, wherein the second nest assembly comprises a plurality of supports spaced apart from one another for holding the external component nestably in a predetermined orientation and position relative to the first nest assembly, above the support table.

8. The apparatus of claim 7, wherein the plurality of supports are secured to an intermediate platform to form a unitary assembly.

9. The apparatus of claim 1, further comprising a pneumatic circuit for helping to control movement of the first nest assembly.

10. The apparatus of claim 5, wherein each of the supporting sections includes a removably attached track for enabling the first nest assembly to be configured to accommodate more than one different type of external component.

11. An apparatus for rapidly and accurately applying seal strips to a pair of generally parallel edges of an article carrying component along a predetermined location on the article carrying component, the apparatus comprising:
a support table;
an upper nest assembly having a plurality of vacuum passages leading to vacuum ports, the vacuum ports being formed in a first and second generally parallel channels of the upper nest assembly, the channels being shaped to hold first and second seal strips therein and the channels each having a predetermined length and shape;
a plurality of bearing assemblies for supporting the upper nest assembly for rotational movement relative to the support table;
a lower nest assembly positioned fixedly relative to the support table and configured to removably cradle the article carrying component in a desired orientation, with the edges of the article carrying component facing outwardly;
a vacuum source for supplying a vacuum force to the vacuum ports to hold the seals strips within the channels as the seal strips are manually positioned in the channels by a user, the upper nest assembly further using the vacuum force to hold the seal strips in the channels as the upper nest assembly is rotated towards the lower nest assembly; and
wherein the upper nest assembly applies the seal strips to the edges of the article carrying component with a predetermined force when the upper nest assembly is fully rotated into a position closely adjacent the lower nest assembly, and wherein rotation of the upper nest assembly away from the lower nest assembly allows the article carrying component, with the seal strips secured thereto, to be manually removed from the lower nest assembly.

12. The apparatus of claim 11, further comprising a counterweight operably associated with the upper nest assembly for applying a predetermined counterweight to the upper nest assembly during rotational movement of the upper nest assembly, and further controlling the predetermined force which is applied when pressing the seal strips against the edges of the article carrying component.

13. The apparatus of claim 11, wherein the upper nest assembly includes a plurality of supporting sections secured to one another to form a single assembly, each said supporting section having vacuum passages formed therein, the vacuum passages being in communication with the ports.

14. The apparatus of claim 13, wherein each one of the upper nest assembly includes a removable track to enable the upper nest assembly to be configured to be used to apply the seal strips to differently shaped article carrying components.

15. The apparatus of claim 11, wherein the lower nest assembly comprises:
an intermediate platform; and
a plurality of supports spaced apart for supporting the article carrying component in a cradle-like manner.

16. The apparatus of claim 11, further comprising a user control panel for enabling a user to control operation of the vacuum source.

17. The apparatus of claim 11, further comprising a pneumatic circuit for helping to control movement of the upper nest assembly.

18. A method for rapidly and accurately applying seal strips to a surface of an external component along a predetermined location on the external component, the method comprising:
providing a support table;
using a first nest assembly having a plurality of vacuum passages leading to vacuum ports to hold a seal strip, the vacuum ports further being formed in a channel of the first nest assembly, the channel being shaped to hold the seal strip therein and the channel having a predetermined length and shape;
using at least one bearing assembly to support the first nest assembly for rotational movement relative to the support table;
using a second nest assembly positioned fixedly relative to the support table, to removably hold, in a cradle-like manner, the external component in a desired orientation;
using a vacuum source to supply a vacuum force to the vacuum ports to hold the seal strip within the channel as the seal strip is positioned in the channel by a user;
rotating the nest assembly towards the second nest assembly while the seal strip held is in the channel using the vacuum force;
using the first nest assembly to press the seal strip onto the predetermined location of the external component, with a predetermined force, as the first nest assembly is fully rotated into a position closely adjacent to the second nest assembly; and
rotating the first nest assembly away from the second nest assembly to allow the external component, with the seal strip secured thereto, to be removed from the second nest assembly.

19. The method of claim 18, further comprising using a counterweight to counterbalance a weight of the first nest assembly to thus aid in rotating the first nest assembly towards and away from the second nest assembly.

20. The method of claim 18, further comprising using the first and second nest assemblies to apply a pair of the seal strips simultaneously to a pair of predetermined regions on the external component.
